(19) United States
(12) Patent Application Publication
(10) Pub. No.: US 2025/0156358 A1
(43) Pub. Date: May 15, 2025

(54) ELECTRONIC DEVICE, AND METHOD FOR CONTROLLING SAME

(71) Applicant: SAMSUNG ELECTRONICS CO., LTD., Suwon-si (KR)

(72) Inventor: Jongchul SHIN, Suwon-si (KR)

(73) Assignee: SAMSUNG ELECTRONICS CO., LTD., Suwon-si (KR)

(21) Appl. No.: 19/019,663

(22) Filed: Jan. 14, 2025

Related U.S. Application Data
(63) Continuation of application No. PCT/KR2023/011644, filed on Aug. 8, 2023.

(30) Foreign Application Priority Data
Sep. 29, 2022 (KR) 10-2022-0124033

(51) Int. Cl. G06F 13/40

(52) U.S. Cl. CPC G06F 13/404; G06F 2213/0026

(57) ABSTRACT

There is an electronic device including a first processor, a second processor, and a first interface circuit to transfer a bus command therebetween through a first interface scheme, and the first processor and the second processor each include function blocks, a second interface circuit to transfer a bus command between the function blocks through a second interface scheme different from the first interface scheme, and a bridge circuit to convert data format through the first interface scheme or the second interface scheme, and the bridge circuit is configured to convert, based on determining that a bus command of the second interface scheme that comprises a security indicator has been received, address information in the received bus command to comprise security information, and output to the first interface circuit by converting the bus command having the converted address information through first interface scheme.

### CROSS-REFERENCE TO RELATED APPLICATION

This application is a bypass continuation of PCT International Application No. PCT/KR2023/011644, which was filed on Aug. 8, 2023, and claims priority to Korean Patent Application No. 10-2022-0124033, filed on Sep. 29, 2022 in the Korean Intellectual Property Office, the disclosures of which are incorporated herein by reference in their entireties.

### BACKGROUND

### 1. Field

The disclosure relates to an electronic device and a method for controlling the same, and more particularly, to an electronic device capable of transmitting and receiving security indicator information in an interface scheme that does not use a security indicator and a method for controlling the same.

### 2. Description of Related Art

A System on Chip (SoC) is a chip that implements various functional blocks that configure a system such as a central processing unit (CPU), a graphics processing unit (GPU), a digital signal processor (DSP), an input/output (I/O) controller, and the like into one. Recently, systems are being configured by connecting several SoCs with a high-speed interface to improve performance.

As functions of the SoC have become more varied, personal data of a user as well as copyrighted data are processed in the SoC. The data described above require security, and recent SoCs support technology for preventing unauthorized software access to data that require such security.

However, security functions of the related art operate only in buses that use the same method, and there has been the difficulty of not being able to apply the above-described security operation between heterogeneous buses.

### SUMMARY

There is provided an electronic device including a first processor, a second processor, and a first interface circuit configured to transfer a bus command between the first processor and the second processor through a first interface scheme, wherein the first processor and the second processor each include: a plurality of function blocks; a second interface circuit configured to transfer a bus command between the plurality of function blocks through a second interface scheme different from the first interface scheme; and a bridge circuit configured to convert data format through any of the first interface scheme and the second interface scheme, and wherein the bridge circuit is configured to: convert, based on determining that a bus command of the second interface scheme that comprises a security indicator has been received, address information in the received bus command to comprise security information; and output to the first interface circuit by converting the bus command having the converted address information through first interface scheme.

The bridge circuit may include security information in a pre-set bit location from among the address information represented by the plurality of bits.

The pre-set bit location may consist of a bit size of one.

The bridge circuit may include a register configured to store information on the pre-set bit location.

At least one function block from among the plurality of function blocks may be configured to: confirm an address value not being used in the electronic device; determine a bit location to be added with security information from among the plurality of bits representing address information by using the address value; and store the determined bit location in the register.

The at least one function block may be configured to transmit information on the determined bit location between the first processor and the second processor.

The bridge circuit may be configured to: confirm, based on a bus command of the first interface scheme being received, security information using address information in the received bus command; remove security information from the address information based on the security information being confirmed as information requiring security; and output to the second interface circuit by converting the bus command having a security indicator indicating that the bus command is a request requiring security and address information with the security information removed through the second interface scheme.

The bridge circuit may be further configured to: output, based on the security information being confirmed as information not requiring security, to the second interface circuit by converting the bus command having a security indicator indicating that the bus command is a request that does not require security and the address information through the second interface scheme.

The bridge circuit may be further configured to: convert an external address, included in the address information with the security information removed, to an internal address of one of the first processor and the second processor.

The at least one from among the plurality of function blocks may be a memory controller, and the memory controller may be configured to: confirm the security indicator and address information in the bus command of the second interface scheme; and determine whether to allow access to a memory area corresponding to the address information using a security level and the security indicator corresponding to the address information.

The first interface scheme may be a Peripheral Component Interconnect Express (PCIe) scheme, and the second interface scheme may be an Advanced extensible Interface (AXI) scheme.

There is provided a method for controlling an electronic device comprising a plurality of processors, the method including: receiving, through a second interface circuit in a processor of the plurality of processors, a bus command of a second interface scheme including a security indicator; converting address information in the received bus command to include security information; and outputting, to a first interface circuit in the electronic device, by converting the received bus command including the converted address information through a first interface scheme.

The converting includes: writing security information in a pre-set bit location from among address information represented by a plurality of bits.

There is provided a method for controlling an electronic device including a plurality of processors, the method including: receiving a bus command of a first interface scheme; confirming security information of the bus command based on a pre-set bit location from among a plurality of bits that configure address information in the received bus command; removing the security information from the address information based on determining that the bus command is confirmed as information requiring security; and converting and outputting the bus command, based on determining the bus command as having a security indicator indicating that the bus command is a request requiring security, and the address information, with the security information removed, through a second interface scheme.

The converting and outputting the bus command may include: removing the security information from the address information based on confirming that the address information is information that does not require security; and converting and outputting the bus command based on determining that the bus command comprises a security indicator indicating that the bus command is a request that does not require security, and the address information, with the security information removed through the second interface scheme.

### BRIEF DESCRIPTION OF THE DRAWINGS

Aspects, features, and advantages described above in embodiments of the disclosure will be made clearer through descriptions described below with reference to the accompanied drawings, in which:

FIG. 1 is a diagram illustrating a configuration of an electronic device according to one or more embodiments of the disclosure;

FIG. 2 is a diagram illustrating a configuration of a processor according to one or more embodiments of the disclosure;

FIG. 3 is a diagram illustrating a first conversion operation according to one or more embodiments of the disclosure;

FIG. 4 is a diagram illustrating a second conversion operation according to one or more embodiments of the disclosure;

FIG. 5 is a flowchart illustrating a control operation of an electronic device according to one or more embodiments of the disclosure; and

FIG. 6 is a flowchart illustrating a control operation of an electronic device according to one or more embodiments of the disclosure.

### DETAILED DESCRIPTION

The expression at least one of A and/or B is to be understood as indicating any one of “A”, or “B”, or “A and B”.

Expressions such as “1st”, “2nd”, “first”, or “second” used in the disclosure may limit various elements regardless of order and/or importance, and may be used merely to distinguish one element from another element and not limit the relevant element.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

Embodiments of the disclosure will be described in greater detail below with reference to the accompanied drawings.

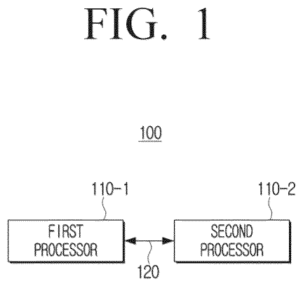

FIG. 1 is a diagram illustrating a configuration of an electronic device according to one or more embodiments of the disclosure.

Referring to FIG. 1, an electronic device 100 may include a plurality of processors, such as first processor 110-1 and second processor 110-2, and a first interface circuit 120. Here, the electronic device 100 may be a device such as, for example, and without limitation, a personal computer (PC), a notebook, a tablet, a server, a portable multimedia player (PMP), a smartphone, a display, a home appliance, and the like, and if interface schemes inside the processor, like any of first processor 110-1 and second processor 110-2, and outside the processor are different, it may be another device other than the above-described devices.

Each of the plurality of processors, such as first processor 110-1 and second processor 110-2, may control each configuration in the electronic device 100. Specifically, in the example shown, it has been shown and described as two processors being included, but at implementation, three or more processors may be included in the electronic device 100 according to one or more embodiments.

The processors, such as first processor 110-1 and second processor 110-2, may each be a processor such as, for example, and without limitation, a central processing unit (CPU), a micro controller unit (MCU), a micro processing unit (MPU), a controller, an application processor (AP), or a communication processor (CP), an advanced reduced instruction set (RISC) machine (ARM) processor, a digital signal processor (DSP), or the like, a graphics dedicated processor such as a graphic processing unit (GPU) or a vision processing unit (VPU), or an artificial intelligence dedicated processor such as an neural processing unit (NPU). In addition, the processors, such as first processor 110-1 and second processor 110-2, may be implemented as a System on Chip (SoC) or a large scale integration (LSI) in which a processing algorithm is embedded, and may be implemented in a form of a field programmable gate array (FPGA).

Internal data may be transmitted and received using a second interface scheme that includes a security indicator that indicates whether a data request (or a bus command) by the processors, such as first processor 110-1 and second processor 110-2, requires security. For example, the second interface scheme may be an Advanced extensible Interface (AXI)™ scheme of ARM. The AXI scheme may be an interface scheme that includes a security indicator in data format, and may be an interface scheme that transfers a security state (or whether security is necessary, etc.) of relevant data (or request) together with a request (or data) using the security indicator. In this disclosure, an example of using the AXI scheme has been provided, but at implementation, an interface scheme that transmits and receives information (or security indicator) indicating a security level (or degree of security) of data (or request) transferred to an interface format together therewith may be used other than the AXI scheme. The security indicator described above may be located at a first bit (ARPROT[1], AWPROT[1]) of each of an ARPROT and AWPROT field of the AXI bus, and may indicate whether reading or writing of data was requested in a secure state or requested in a non-secure state.

Here, data may not only be a specific information, but also a request such as a bus command requesting specific information from another configuration. Further, such data may be referred to as a signal.

As described above, by using the security indicator, a processor 110 may perform an appropriate data access control according to the secure state. Specifically, the processor 110 may confirm an address and a value of the security indicator in the bus command, compare a security level set in pre-stored data corresponding to the relevant address and the value of the security indicator in the bus command, determine whether the relevant data is accessible according to the comparison result, and perform data processing based on the result thereof.

For example, with respect to access requests for data with a low security level or with no security setting, access to data may be authorized regardless of the security indicator value, but with respect to access requests for data with a security level setting or high security level, access to relevant data may be denied if the relevant access request security indicator value is not the security indicator value indicating that it is in the secure state.

Further, the processors, such as first processor 110-1 and second processor 110-2, may transmit and receive data with another configuration of the electronic device through a first interface scheme. To this end, the processors, such as first processor 110-1 and second processor 110-2, may include a bridge circuit which converts data format into the first interface scheme or the second interface scheme.

The bridge circuit not only converts the interface scheme, but may also perform operations such as, when transmitting a signal to an outside, transmitting the security indicator (or security information, or secure state information) in the second interface scheme to the outside by embedding the security indicator in the address information (or address field) in the first interface scheme, and when receiving data in the first interface scheme, obtaining security information by using a bit value in a specific bit location in the address information (or an address field) in the received data when receiving data through the first interface scheme, and generating a security indicator in the second interface scheme based on the obtained security information.

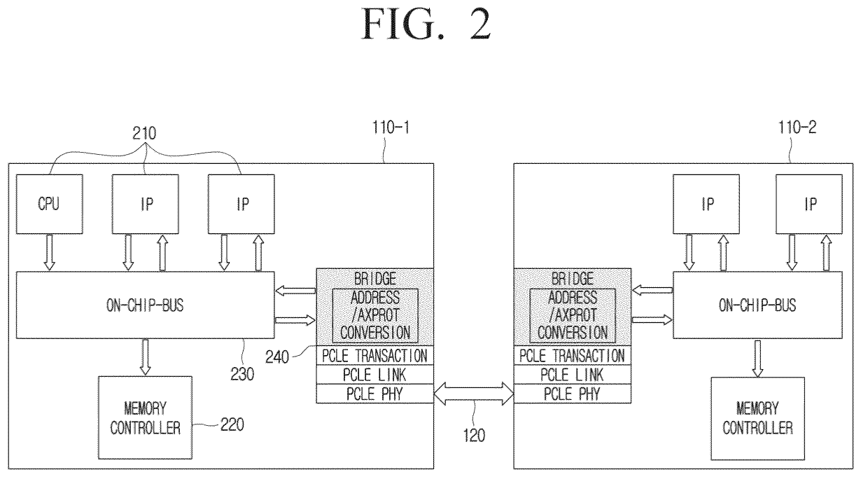

The specific configuration and operation of the processor 110 according to one or more embodiments will be described below with reference to FIG. 2.

The first interface circuit 120 may transmit and receive signals between configurations in the electronic device 100. Specifically, the first interface circuit 120 may transfer data between a first processor 110-1 and a second processor 110-2 through the first interface scheme.

For example, the first interface scheme may be a Peripheral Component Interconnect Express (PCIe) scheme. Here, PCIe may be a high-speed serial bus that transmits and receives a signal between chips in the electronic device. In the disclosure, PCIe has been provided as an example, but so long as it is a serial interface scheme in which an indicator indicating whether it is security request of the interface format is not included, an interface scheme other than PCIe may be used according to one or more embodiments.

The electronic device 100 according to the disclosure as described above may transfer information (or field value) associated with security used inside to another configuration in the electronic device 100 without loss even when the outside and inside of the processor operate with different interface schemes, and accordingly, the processor may perform an appropriate access control according to the secure state for not only an internal data request, but also for other requests by the processor.

Meanwhile, in showing and describing FIG. 1, the electronic device 100 has been shown and described as including only the processors, such as first processor 110-1 and second processor 110-2, and the first interface circuit 120, but at implementation, various configurations (e.g., a communication device for communicating with external devices, a storage device for storing data, a display, a touch screen, etc.) associated with functions of the relevant electronic device in addition to the above-described configurations may be further included.

FIG. 2 is a diagram illustrating a configuration of a processor according to an embodiment of the disclosure.

Referring to FIG. 2, the electronic device 100 may include the first processor 110-1, the second processor 110-2, and the first interface circuit 120. The first processor 110-1 and the second processor 110-2 may be the same processor, and may be processors that perform different functions from each other.

The processors, such as first processor 110-1 and second processor 110-2, may include a plurality of function blocks 210, a memory controller 220, a second interface circuit 230, and a bridge circuit 240.

The plurality of function blocks 210 may be blocks performing a specific function, and may be referred to as a core, a CPU, an intellectual property (IP) core, a GPU, and the like. In the disclosure, three function blocks have been shown as included, but at implementation according to one or more embodiments, only one function block may be included, and four or more function blocks may be included.

At least one from among the plurality of function blocks may determine a bit location to which security information is to be added in an address signal of a first interface format which will be described below, and notify information on the relevant bit location to another processor. Specifically, one function block may confirm an address range that the electronic device 100 uses, and determine the bit location to add the security information by using the confirmed address range.

For example, in PCIe, a 32-bit (or 64-bit) size address field is used. However, if the address range that is actually used is 30 bit, the upper two bits are not actually used as address information. Accordingly, the function block may determine a bit location that is not used in the transferring of the address information as the above-described bit location. For example, the above-described two bits may be the bit location of the upper area that represents address information (or address field). The location as described may be changed to a specific condition (or periodically), and enhance security.

The memory controller 220 may perform a reading/writing operation for data stored in the memory corresponding to a request requested through a second interface. At this time, the memory controller 220 may determine whether to allow reading/writing of the relevant data based on the value of the security indicator in the data transferred through the second interface scheme and the secure state corresponding to the address information requested by the relevant data. For example, if the reading request for data that requires security is requested for data having the security indicator value rather than the secure state, the memory controller 220 may deny the relevant reading request.

The bridge circuit 240 may convert data format into the first interface scheme or the second interface scheme. Specifically, the bridge circuit 240 may change to a structure that matches the second interface scheme with respect to data received through the first interface scheme, and change to a structure that matches the second interface scheme with respect to data received through the second interface scheme. PHY indicating physical layer, PCLE indicating peripheral component interconnect express.

At this time, the bridge circuit 240 may change the address information. For example, the first interface scheme is to have an external address, and the second interface scheme may be expressed as an internal address. Accordingly, according to a setting in the processor 110, an operation of changing the address information from an internal address scheme (or address space) to an external address scheme (or address space), or changing the external address scheme (or address space) to the internal address scheme (or address space) may be performed.

Further, the bridge circuit 240 may perform embedding of security information corresponding to the security indicator in the address information. Specifically, the bridge circuit may convert, based on data of the second interface scheme that includes the security indicator being received, the address information in the received data to include the security information, and output to the first interface circuit by converting data having the converted address information through the first interface scheme. For example, the security information may be included in a pre-set bit location from among the address information expressed by a plurality of bits. The pre-set bit location as described above may be predetermined, and may be changed periodically. Further, the information on the relevant bit location may be stored in a register.

Then, the bridge circuit 240 may confirm, based on data of the first interface scheme being received, the security information using the address information in the received data.

Further, the bridge circuit 240 may remove the security information from the address information when it is confirmed as information requiring security, and output to the second interface circuit by converting data having a security indicator indicating that it is a request requiring security and address information with the security information removed through the second interface scheme. Meanwhile, the example as described above is because of having performed a conversion process to include security information in a specific bit of the address information when security is required as described above. If there is no security required at implementation, the security information may be included in the specific bit, and if implemented in a form that does not include the security information if there is no security required, the operation for removing the security information even when security is required may not be performed. In addition, the expression of removing the security information from the above-described address information may be expressed as performing decoding of the address information with the original address information.

Conversely, if confirmed as information that does not require security, the bridge circuit 240 may convert the security indicator that indicates that it is a request that does not require security and data having the received address information through the second interface scheme and output to the second interface circuit.

Meanwhile, in showing and describing FIG. 1 and FIG. 2, it has been shown and described as embedding the security information in the address information (or address field) of a first interface. The reason for the above is because of all interfaces (or buses) regardless of type using the address information (address field). Although an example of embedding security information in the address information has been described, at implementation according to one or more embodiments, so long as the security information is a field having a size of information size in which there is no loss to the original information even if the security information is embedded, the security information may be implemented in a form embedded in another field other than the above-described address information.

Meanwhile, in showing and describing FIG. 1 and FIG. 2, the security information has been described as being embedded in the address information only when security is required. That is, the security information has been described as being selectively embedded according to whether security is required. However, at implementation, the security information according to one or more embodiments may be implemented in a form that is constantly embedded in the address information regardless of whether security is required. For example, the security information may be implemented in a form of embedding security information at a first bit location if security is required for using two bit locations, and embedding security information at a second bit location if security is not required. As described above, using two bit locations, it is possible according to one or more embodiments to implement not only a function of transferring security information but also authenticating whether the security information was appropriately embedded. In addition, it is possible according to one or more embodiments to implement embedding of not only whether security is required using a plurality of bit locations, but also a value of security level.

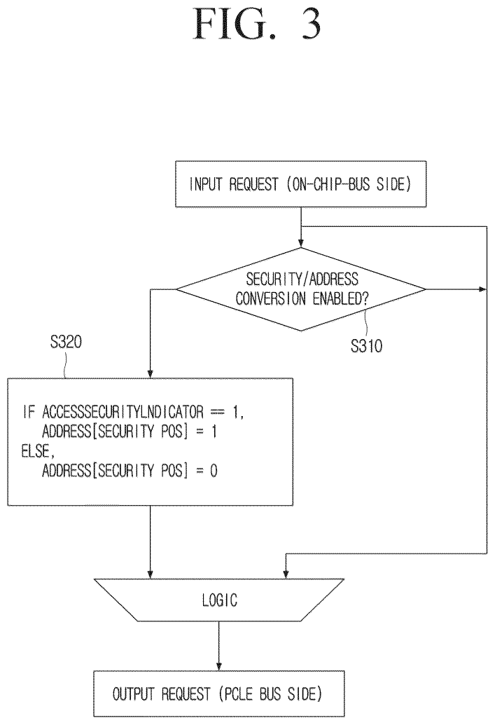

FIG. 3 is a diagram illustrating a first conversion operation according to according to one or more embodiments of the disclosure.

Referring to FIG. 3, whether embedding of security information in the address information is required may be confirmed (S310). Information on whether the above is required may be stored in a specific register, and whether to perform embedding of security information in the address information may be determined according to information of the relevant register.

Specifically, because the disclosure describes of performing an operation of converting address information, normal operation is possible only in another chip capable of recognizing an algorithm of the disclosure. Accordingly, when transmitting and receiving data between devices applied with the same algorithm, the operation may be determined as performing the conversion operation of the security information, and when transmitting and receiving data between devices which were not applied with the same algorithm, the operation may be determined as not performing the conversion operation of the security information.

In addition to the above-described reason, in a state (or circumstance) (e.g., at initial booting or in a system setting, etc.) in which the security indicator is not used in the bus inside the processor, as there is no need to perform the above-described conversion, an operation of changing only the interface format may be performed without a separate conversion operation.

Accordingly, if embedding of the security information is not required, data may be transmitted outside the processor by performing the operation of changing only the interface format.

Meanwhile, if embedding of security information is required, an operation of adding security information (i.e., indicator) to the address information in the data may be performed (S320). POS indicating position. For example, if a value of the security indicator is 1, a value of a specific bit from among the plurality of bits in the address information may be changed to 1. Conversely, if the value of the security indicator is 0, the value of the specific bit from among the plurality of bits in the address information may be maintained at 0. In other words, if the value of the security indicator has a value indicating that security is required, embedding of adding security information in the address information may be performed, and if the value of the security indicator has a value that does not require security, an operation of converting address information may not be performed.

Meanwhile, at implementation, opposite to the above-described operation, if the value of the security indicator has a value indicating that security is required, the address information may not be converted, and if the value of the security indicator indicates that security is not required, an operation of converting the address information may be performed.

Meanwhile, information on a location to which the security information is to be added in the address information may be stored in advance in the register, and the relevant information may be a bit location relevant to an address range that is not actually used from among the address range that can be used by the electronic device. Further, the relevant bit location may be one bit size. In the disclosure, although it has been described as using only one bit size, if the bit size that configure the address information is sufficiently large, and the security information is not configured as 1 or 0, and a degree of security is divided for example, if it is 0 (secure state 0), 1 (secure state 1), 2 (secure state 2), and the like, the plurality of bits may be used.

Further, the determination on the location as described may be performed by a master processor from among a plurality of processors, a master first processor 110-1 may determine the bit location to which the security information is to be embedded, and provide information on the determined bit location to another second processor 110-2. Meanwhile, at implementation, for information on the above-described location, the first interface scheme (e.g., PCIe) described above may be used, and the information may be transferred using another interface scheme other than the first interface scheme. In addition, the above-described determining operation may be performed periodically or according to an occurrence if a specific event. For example, because the electronic device 100 uses a pre-set location at a turned-on time-point, when a certain time-point is passed, the master first processor 110-1 may determine another location and transfer to another device, and may repeat the above-described changing operation according to a pre-set period (or the occurrence of the event).

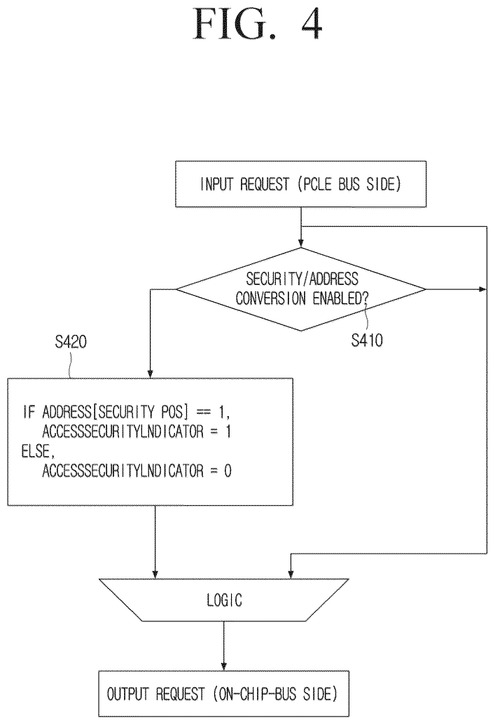

FIG. 4 is a diagram illustrating a second conversion operation according to one or more embodiments of the disclosure.

Referring to FIG. 4, whether embedding of the security information is required in the address information may be confirmed (S410). Information on whether the above is required may be stored in a specific register, whether to perform embedding of the security information in the address information may be determined according to information of the relevant register. Because the operation has been described with respect to S310 of FIG. 3, redundant descriptions thereof will be omitted.

If the function of embedding the security information in the address information is not activated, data received without a separate operation of converting address information may be transmitted to an inside bus by performing a process of changing only the interface format.

If the function of embedding the security information in the address information is activated, whether to include security information may be confirmed through the pre-set location in the address information (S420). For example, if a value of a specific bit in the address information is 1, it may be determined as including information that requires security, the value of the relevant specific bit may be changed to 0 and restored (or decoded) to the original address information, and an indicator value notifying that security is required may be generated. If a value of a specific bit in the address information is 0, it may be determined as a request that does not require security, and an indicator value that does not require security may be generated without change to the address information.

Meanwhile, at implementation, the above-described operation may be changed according to which scheme the security information is to be embedded in the address information.

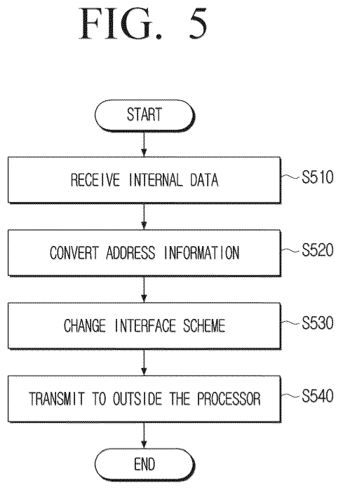

FIG. 5 is a flowchart illustrating a control operation of an electronic device according to one or more embodiments of the disclosure.

First, data of the second interface scheme that includes the security indicator may be received through the second interface circuit in the processor (S510). For example, the second interface scheme may be an AXI scheme, and a first bit of an ARPROT filter and an AWPROT filter of the AXI scheme may be information indicating the above-described security indicator.

Then, the address information in the received data may be changed to include the security information (S520). Specifically, security information corresponding to the security indicator may be included in a value of a predetermined specific bit from among a plurality of bit values that include the address information in the received data. For example, if the security indicator value is 1, the security information may also be embedded to 1, and it is possible according to one or more embodiments to perform embedding by reversing the security indicator value and a value of security information.

Further, data with the converted address information may be converted through the first interface scheme which is different from the second interface scheme and output to the first interface circuit in the electronic device (S530). Specifically, the security information may be included in a pre-set specific bit location from among the address information expressed by the plurality of bits. In an interface conversion scheme as described, a process of not only the changing the data format, but also changing the address information from the external address to the internal address is included according to one or more embodiments.

As described, because a control operation of the disclosure includes embedding security indicator information using an unused bit from among the address information, it is possible according to one or more embodiments to transfer security indicator information to another chip even if different buses from each other are used between the inside and outside of the chip.

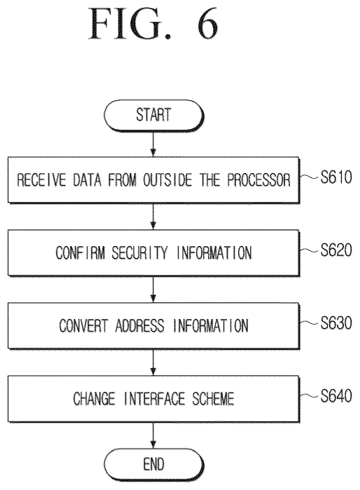

FIG. 6 is a flowchart illustrating a control operation of an electronic device according to one or more embodiments of the disclosure.

First, data of the first interface scheme (or bus command) is received from outside of the processor (S610). For example, the first interface scheme is the PCIe scheme according to one or more embodiments, but the first interface scheme (or bus command) is not limited thereto.

Then, the security information may be confirmed using the address information in the received data (S620). Specifically, the security information may be confirmed by confirming of the predetermined specific bit location of the plurality of bit that configure the address information. The specific bit location as described may be a fixed location, and may vary according to circumstance according to one or more embodiments.

Then, when it is confirmed as information requiring security, the security information is removed from the address information, and data with the security indicator indicating that the data is a request requiring security and address information with the security information removed is converted through the second interface scheme (S630). Conversely, if it is confirmed as information that does not require security, the security information may be moved from the address information, and data with the security indicator indicating that the data is a request that does not require security and address information with the security information removed may be converted through the second interface scheme. In the interface conversion scheme as described, the process of not only changing the data format but also of changing the address information from the external address to the internal address is also included according to one or more embodiments. In addition, as the above-described operation is associated with an encoding scheme of the security information, when implemented through a scheme that encodes address information even when security is not required, the above-described operation is implemented in a form of the address information being decoded when security is not required and the address information not being decoded when security is required according to one or more embodiments.

Because the control operation according to the disclosure as described performs embedding of the security indicator information by using an unused bit from among the address information, it may be possible to transfer the security indicator information to another chip even when different buses from each other are used between the inside and outside of the chip.

Meanwhile, according to one or more embodiments of the disclosure, the various embodiments described above are implemented with software including instructions stored in a machine-readable storage media (e.g., computer). The machine calls a stored instruction from the storage medium, and as a device operable according to the called instruction, includes the electronic device according to the above-mentioned embodiments. Based on a command being executed by a processor, the processor directly or using other elements under the control of the processor performs a function corresponding to the command. The command includes a code generated by a compiler or executed by an interpreter. A machine-readable storage medium is provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to one or more embodiments of the disclosure, a method according to the various embodiments described above is provided included a computer program product. The computer program product may be exchanged between a seller and a purchaser as a commodity. The computer program product is distributed in a form of the machine-readable storage medium (e.g., a compact disc read only memory (CD-ROM)), or distributed online through an application store (e.g., PLAYSTORE™). In the case of online distribution, at least a portion of the computer program product is stored at least temporarily in the machine-readable storage medium such as a server of a manufacturer, a server of an application store, or a memory of a relay server, or temporarily generated.

Meanwhile, according to one or more embodiments, the various embodiments described above are implemented in a recordable medium which is readable by computer or a device similar to computer using software, hardware, or the combination of software and hardware. In some cases, the embodiments described herein are implemented by the processor itself. According to a software implementation, embodiments such as the procedures and functions described herein may be implemented with separate software modules. Each of the software modules may perform one or more of the functions and operations described herein.

Meanwhile, computer instructions for performing processing operations in a device according to the various embodiments described above may be stored in a non-transitory computer-readable medium. The computer instructions stored in this non-transitory computer-readable medium cause a specific device to perform a processing operation of the device according to the above-described various embodiments when executed by a processor of the specific device. The non-transitory computer-readable medium refers to a medium that stores data semi-permanently rather than storing data for a very short time, such as a register, a cache, a memory, or the like, and is readable by a device. Specific examples of the non-transitory computer-readable medium include, for example, and without limitation, a compact disc (CD), a digital versatile disc (DVD), a hard disc, a Blu-ray disc, a USB, a memory card, a ROM, and the like.

In addition, each of the elements (e.g., a module or a program) according to various embodiments described above are configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the disclosure is intended to be illustrative, not limiting. It will be understood by those skilled in the art that various changes in form and details may be made therein without departing from the true spirit and full scope of the disclosure, including the appended claims and their equivalents.

What is claimed is:

1. An electronic device, comprising:
a first processor;
a second processor; and
a first interface circuit configured to transfer a bus command between the first processor and the second processor through a first interface scheme,
wherein the first processor and the second processor each comprise:
a plurality of function blocks;
a second interface circuit configured to transfer a bus command between the plurality of function blocks through a second interface scheme different from the first interface scheme; and
a bridge circuit configured to convert data format through any of the first interface scheme and the second interface scheme, and
wherein the bridge circuit is configured to:
convert, based on determining that a bus command of the second interface scheme that comprises a security indicator has been received, address information in the received bus command to comprise security information; and
output to the first interface circuit by converting the bus command having the converted address information through first interface scheme.

2. The electronic device of claim 1, wherein
the bridge circuit comprises security information in a pre-set bit location from among the address information represented by the plurality of bits.

3. The electronic device of claim 2, wherein the pre-set bit location consists of a bit size of one.

4. The electronic device of claim 2, wherein the bridge circuit further comprises:
a register configured to store information on the pre-set bit location.

5. The electronic device of claim 4, wherein
at least one function block from among the plurality of function blocks is configured to:
confirm an address value not being used in the electronic device;
determine a bit location to be added with security information from among the plurality of bits representing address information by using the address value; and
store the determined bit location in the register.

6. The electronic device of claim 4, wherein the at least one function block is configured to transmit information on the determined bit location between the first processor and the second processor.

7. The electronic device of claim 1, wherein the bridge circuit is configured to:
confirm, based on a bus command of the first interface scheme being received, security information using address information in the received bus command;
remove security information from the address information based on the security information being confirmed as information requiring security; and
output to the second interface circuit by converting the bus command having a security indicator indicating that the bus command is a request requiring security and address information with the security information removed through the second interface scheme.

8. The electronic device of claim 7, wherein the bridge circuit is further configured to:
output, based on the security information being confirmed as information not requiring security, to the second interface circuit by converting the bus command having a security indicator indicating that the bus command is a request that does not require security and the address information through the second interface scheme.

9. The electronic device of claim 7, wherein the bridge circuit is further configured to:
convert an external address, comprised in the address information with the security information removed, to an internal address of one of the first processor and the second processor.

10. The electronic device of claim 1, wherein
at least one from among the plurality of function blocks is a memory controller, and
the memory controller is configured to:
confirm the security indicator and address information in the bus command of the second interface scheme; and
determine whether to allow access to a memory area corresponding to the address information using a security level and the security indicator corresponding to the address information.

11. The electronic device of claim 1, wherein
the first interface scheme is a Peripheral Component Interconnect Express (PCIe) scheme, and
the second interface scheme is an Advanced extensible Interface (AXI) scheme.

12. A method for controlling an electronic device comprising a plurality of processors, the method comprising:
receiving, through a second interface circuit in a processor of the plurality of processors, a bus command of a second interface scheme comprising a security indicator;
converting address information in the received bus command to comprise security information; and
outputting, to a first interface circuit in the electronic device, by converting the received bus command comprising the converted address information through a first interface scheme.

13. The method of claim 12, wherein the converting comprises:
writing security information in a pre-set bit location from among address information represented by a plurality of bits.

14. A method for controlling an electronic device comprising a plurality of processors, the method comprising:
receiving a bus command of a first interface scheme;
confirming security information of the bus command based on a pre-set bit location from among a plurality of bits that configure address information in the received bus command;
removing the security information from the address information based on determining that the bus command is confirmed as information requiring security; and
converting and outputting the bus command, based on determining the bus command as having a security indicator indicating that the bus command is a request requiring security, and the address information, with the security information removed, through a second interface scheme.

15. The method of claim 14, wherein converting and outputting the bus command comprises:
removing the security information from the address information based on confirming that the address information is information that does not require security; and
converting and outputting the bus command based on determining that the bus command comprises a security indicator indicating that the bus command is a request that does not require security, and the address information, with the security information removed through the second interface scheme.
